(19) United States
(12) Patent Application Publication
(10) Pub. No.: US 2021/0157881 A1
(43) Pub. Date: May 27, 2021

(54) OBJECT ORIENTED SELF-DISCOVERED COGNITIVE CHATBOT

(71) Applicant: International Business Machines Corporation, Armonk, NY (US)

(72) Inventors: Tinny Mei Chi Ng, Toronto (CA); Diana Lau, Richmond Hill (CA)

(21) Appl. No.: 16/691,726

(22) Filed: Nov. 22, 2019

(51) Int. Cl. G06F 17/28; G06F 17/24; G06N 5/04; H04L 12/58

(52) U.S. Cl. CPC G06F 17/2881; H04L 51/02; G06N 5/04; G06F 17/241

(57) ABSTRACT

A computer-implemented system and method for searching comprises a processor to respond to a question received from a user during a messaging session. The question is analyzed into respective annotated portions associated with predetermined attributes of the question, including a question type and part of speech. A data model is identified using mapping information defined in the data model with only analyzed predetermined attributes of the question. Relationships are traversed among the data model identified, in a database, using the mapping information. Corresponding values associated with the relationships are retrieved from the database data, and a response to the question is generated using the corresponding values retrieved.

### BACKGROUND

Disclosed herein is a system and related method for an object oriented self-discovered cognitive chatbot. Currently, when training a chatbot, one must provide the information about the entity names and the associated data. There are two major problems with this. First, the dataset can be huge and dynamic. Even with some minor changes in the data, the chatbot needs to be trained again in order to stay correct. Second, there may be many combinations of how the data are related to each other. It is very tedious and error-prone to enlist all the relationships among them.

### SUMMARY

According to one aspect disclosed herein, a computer-implemented method uses a processor to respond to a question received from a user during a messaging session. The question is analyzed into respective annotated portions associated with predetermined attributes of the question, including a question type and part of speech. A data model is identified using mapping information defined in the data model with only analyzed predetermined attributes of the question. Relationships are traversed among the data model identified, in a database, using the mapping information. Corresponding values associated with the relationships are retrieved from the database data, and a response to the question is generated using the corresponding values retrieved.

According to another aspect disclosed herein, a cognitive chatbot system comprise a processor configured to in response to receiving a question from a user during a messaging session, analyze the question into respective annotated portions associated with predetermined attributes of the question including a question type and part of speech. The processor also identifies a data model using mapping information defined in the data model with only analyzed predetermined attributes of the question. The processor traverses relationships among the data model identified, in a database, using the mapping information, and retrieves corresponding values associated with the relationships from the database data. The processor generates a response to the question using the corresponding values retrieved.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 depicts a cloud computing environment according to an embodiment of the present invention.

FIG. 2 depicts abstraction model layers according to an embodiment of the present invention.

FIG. 3 is a block diagram of a DPS according to one or more embodiments disclosed herein.

FIG. 4 is a block diagram of one or more embodiments of a cognitive chatbot system, according to some implementations.

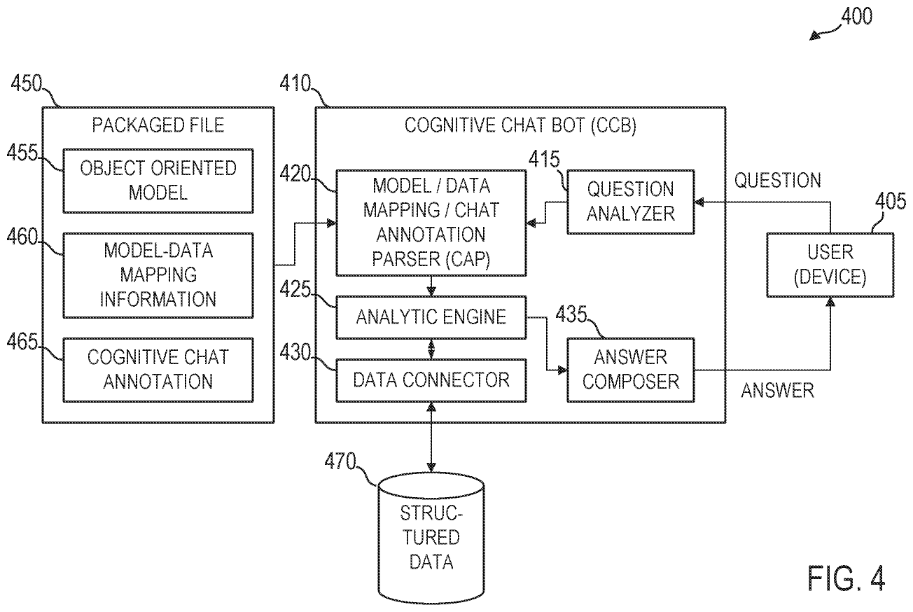

FIG. 5 is a flowchart of one or more embodiments of a process for a cognitive chatbot system disclosed herein.

### DETAILED DESCRIPTION

In order to better provide information to a user, an object oriented self-discovered cognitive chatbot is provided that can intelligently traverse a database for information related to a user's question. Historically, one was required to train chatbots with initial information, but then retrain them if any changes were made. This requires considerable time and effort. The disclosure herein helps reduce or eliminate this considerable time and effort in that data obtained from the database is obtained at a data schema level, not a data instance level.

The following acronyms may be used below:
API application program interface
ARM advanced RISC machine
CD-ROM compact disc ROM
CMS content management system
CoD capacity on demand
CPU central processing unit
CUoD capacity upgrade on demand
DPS data processing system
DVD digital versatile disk
EPROM erasable programmable read-only memory
FPGA field-programmable gate arrays
HA high availability
IaaS infrastructure as a service
EO input/output
IPL initial program load
ISP Internet service provider
ISA instruction-set-architecture
LAN local-area network
LPAR logical partition
PaaS platform as a service
PDA personal digital assistant
PLA programmable logic arrays
RAM random access memory
RISC reduced instruction set computer
ROM read-only memory
SaaS software as a service
SLA service level agreement
SRAM static random-access memory
WAN wide-area network

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

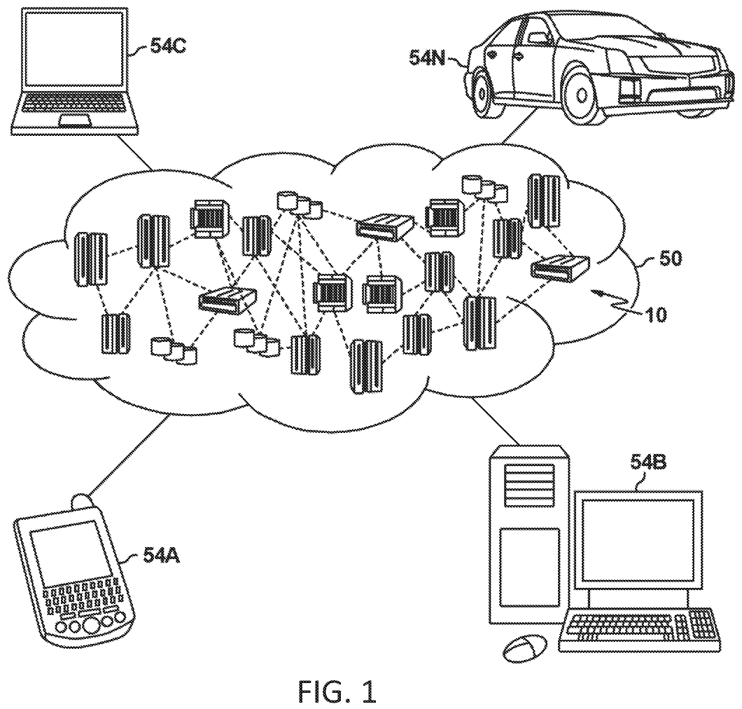

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

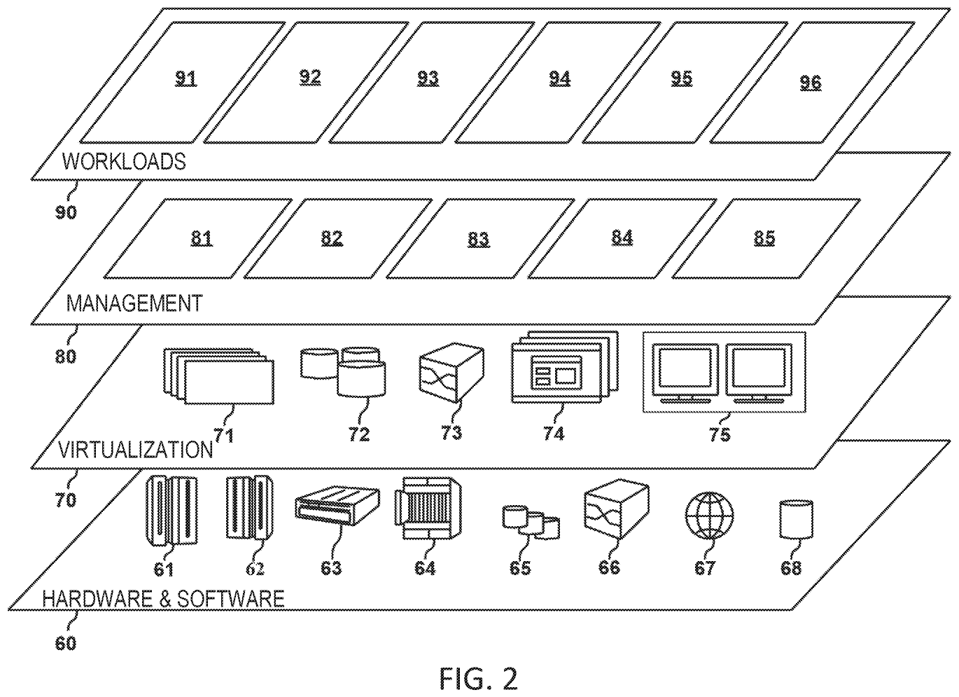

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

### Data Processing System in General

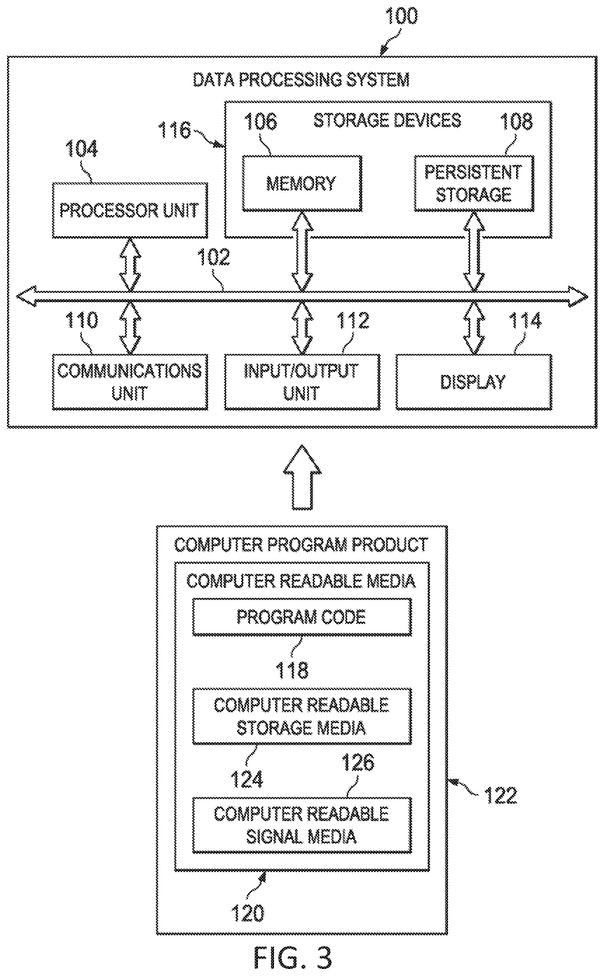

FIG. 3 is a block diagram of an example DPS according to one or more embodiments. The DPS may be used as a cloud computing node 10. In this illustrative example, the DPS 100 may include communications bus 102, which may provide communications between a processor unit 104, a memory 106, persistent storage 108, a communications unit 110, an I/O unit 112, and a display 114.

The processor unit 104 serves to execute instructions for software that may be loaded into the memory 106. The processor unit 104 may be a number of processors, a multi-core processor, or some other type of processor, depending on the particular implementation. A number, as used herein with reference to an item, means one or more items. Further, the processor unit 104 may be implemented using a number of heterogeneous processor systems in which a main processor is present with secondary processors on a single chip. As another illustrative example, the processor unit 104 may be a symmetric multi-processor system containing multiple processors of the same type.

The memory 106 and persistent storage 108 are examples of storage devices 116. A storage device may be any piece of hardware that is capable of storing information, such as, for example without limitation, data, program code in functional form, and/or other suitable information either on a temporary basis and/or a permanent basis. The memory 106, in these examples, may be, for example, a random access memory or any other suitable volatile or non-volatile storage device. The persistent storage 108 may take various forms depending on the particular implementation.

For example, the persistent storage 108 may contain one or more components or devices. For example, the persistent storage 108 may be a hard drive, a flash memory, a rewritable optical disk, a rewritable magnetic tape, or some combination of the above. The media used by the persistent storage 108 also may be removable. For example, a removable hard drive may be used for the persistent storage 108.

The communications unit 110 in these examples may provide for communications with other DPSs or devices. In these examples, the communications unit 110 is a network interface card. The communications unit 110 may provide communications through the use of either or both physical and wireless communications links.

The input/output unit 112 may allow for input and output of data with other devices that may be connected to the DPS 100. For example, the input/output unit 112 may provide a connection for user input through a keyboard, a mouse, and/or some other suitable input device. Further, the input/output unit 112 may send output to a printer. The display 114 may provide a mechanism to display information to a user.

Instructions for the operating system, applications and/or programs may be located in the storage devices 116, which are in communication with the processor unit 104 through the communications bus 102. In these illustrative examples, the instructions are in a functional form on the persistent storage 108. These instructions may be loaded into the memory 106 for execution by the processor unit 104. The processes of the different embodiments may be performed by the processor unit 104 using computer implemented instructions, which may be located in a memory, such as the memory 106.

These instructions are referred to as program code, computer usable program code, or computer readable program code that may be read and executed by a processor in the processor unit 104. The program code in the different embodiments may be embodied on different physical or tangible computer readable media, such as the memory 106 or the persistent storage 108.

The program code 118 may be located in a functional form on the computer readable media 120 that is selectively removable and may be loaded onto or transferred to the DPS 100 for execution by the processor unit 104. The program code 118 and computer readable media 120 may form a computer program product 122 in these examples. In one example, the computer readable media 120 may be computer readable storage media 124 or computer readable signal media 126. Computer readable storage media 124 may include, for example, an optical or magnetic disk that is inserted or placed into a drive or other device that is part of the persistent storage 108 for transfer onto a storage device, such as a hard drive, that is part of the persistent storage 108. The computer readable storage media 124 also may take the form of a persistent storage, such as a hard drive, a thumb drive, or a flash memory, that is connected to the DPS 100. In some instances, the computer readable storage media 124 may not be removable from the DPS 100.

Alternatively, the program code 118 may be transferred to the DPS 100 using the computer readable signal media 126. The computer readable signal media 126 may be, for example, a propagated data signal containing the program code 118. For example, the computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 118 may be downloaded over a network to the persistent storage 108 from another device or DPS through the computer readable signal media 126 for use within the DPS 100. For instance, program code stored in a computer readable storage medium in a server DPS may be downloaded over a network from the server to the DPS 100. The DPS providing the program code 118 may be a server computer, a client computer, or some other device capable of storing and transmitting the program code 118.

The different components illustrated for the DPS 100 are not meant to provide architectural limitations to the manner in which different embodiments may be implemented. The different illustrative embodiments may be implemented in a DPS including components in addition to or in place of those illustrated for the DPS 100. Other components shown in FIG. 1

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

When training a chatbot with a traditional method, one must provide the information about the entity names and the associated data. There are two major problems with this. First, the dataset can be huge and dynamic. Even with some minor changes in the data, the chatbot needs to be trained again in order to stay correct. Second, there may be many combinations of how the data are related to each other. It is very tedious and error-prone to enlist all the relationships among them.

The following illustrations, examples, and use cases illustrate the technical benefits of utilizing a chat annotation as a descriptive language that performs an analysis at a data schema or model level, not at a data level, as has been historically done. Users' questions are analyzed based on parts of speech and question type that are captured and processed using a descriptive model-level language. The chatbot does not generate an answer that is based directly on data, but rather generates an answer that is based on an object model, data mapping, and chat annotation, as described above. The chatbot traverses relationships related to a question that may be answered from information in a database using an object model, and retrieves data values based on data mapping. It then identifies an answer by matching parts of speech with the corresponding model annotation.

Advantageously, the chatbot does not need explicit linking to link questions and answers-instead, it may leverage the object model and its relationships to determine an answer. The answer may be composed by using rules based on a descriptive language. Also, in this system, there is no need to retrain the chatbot as long as the data models stay unchanged. Relationships among the data are self-discovered through inspecting the data model, implying there is no need to specify numerous possible combination of relationships manually. By using this part-of-speech data model along with data mapping information, a data agnostic self-discovered cognitive chatbot that is model-driven instead of data-driven is achieved.

To illustrate this, use cases will be provided in which a chatbot is dedicated to one conference, entitled The World Of Watson® (WOW). Historically, if the speakers of a particular workshop change, then the chatbot needs to be re-trained, since the data is not retrieved dynamically. In this simple use case, each workshop has a location, a speaker list, and attendee list. A participant, who might be a speaker or attendee of a particular workshop, may also have his/her own profile information attributes. In existing systems, it is difficult to list all the possible combinations of how the different data elements can be connected. Also, in the use cases, when the same WOW conference is held again in the following year, the chatbot must be retrained again with a new set of data, despite the fact that although the data will be different, the model itself is the same.

Various embodiments discussed herein address these issues by providing a system and apparatus of a cognitive chatbot in which: a) the entities and the intent of the questions are defined at the data model level instead of at the data level; and b) relationships of the data can be traversed during runtime instead of being pre-defined during training time. This advantageously allows that: 1) there is no need to retrain the chatbot as long as the data models stay unchanged; and 2) relationships among the data may be self-discovered through inspecting the data model, implying there is no need to specify numerous possible combination of relationships manually.

According to some embodiments, the cognitive chatbot is composed of five components:

Model/Data Mapping/Chat Annotation Parser (MDMCAP) 420

The MDMCAP 420 is configured to parse the input question and interpret the object oriented (OO) model/model-data mapping/chat annotation for the analytic engine 425 to interpret. The MDMCAP 420 is designed to parse a packaged file 450 that contains: i) an OO model 455 that contains object oriented information; ii) model-data mapping 460 that contains information for mapping the model with the data in the database 470; and iii) cognitive chat annotation 465 the contains the new descriptive language described here. JAVA is an example of a language that contains OO information for the OO model 455, but other OO languages such as C++ and the like may be utilized as well. JPA is an example of other model-data mapping annotation 460, but other mapping annotations, such as Hibernate, may be utilized as well.

The OO model 455 is object-oriented information that may be, by way of example, captured as a Java object-oriented language class. Other OO languages, for example, C++ and the like, may be used as well. For example, a Java class in the use cases may be defined as:

Listing 1
Workshop Class Definition

| | |
|---|---|
| class WS { | // workshop |

| | |
|---|---|
| String _n; | // title of the workshop |
| String _r; | // room of the workshop |
| String _org; | // organizer of the workshop |

}

Model-data mapping is information for mapping the model with the data in the database, and may utilize the model-data mapping information 460. For example: captured as a Java Persistence Application Programming Interface (API) (JPA) in the Java class:

Listing 2
Model/Data Mapping JPA

@Entity
@Table(name=“WkShop”)
class WS {

@Column(name=“wktitle”) String _n;
@Column(name=“room”) String _r;
@Column(name=“chair”) String _org;

}

TABLE 1
Example Workshop Table
WkShop

| wktitle | room | chair |
|---|---|---|
| Introduction to Watson | Conf. Ctr. 1 | Diana Lau |
| IBM Cloud ® for developers | Room A | Tinny Ng |

“Cognitive Chat Annotation” 465 is a new descriptive language defined herein. It defines the following classes:

TABLE 2
Chat Annotation Classes

| Class | Use |
|---|---|
| @C_Entity | Mark a class as an entity for the chatbot to use |
| | (classes not marked will not be analyzed). |
| @C_Noun(<input>) | Noun used to describe this class. |

Chat annotation also defines the following class attributes:

TABLE 3
Chat Annotation Class Attributes

| Class Attribute | Use |
|---|---|
| @C_Entity_Value | This designates a specific attribute of a class |
| | to represent the object, and is the pronoun of |
| | the entity. It marks one of the attributes as an |
| | entity identity. There is only one per entity, |
| | and its value represents the entity. |
| @C_Noun(<input>) | Noun used to describe this attribute. This |
| | elaborates the class attributes with a part of |
| | the speech context. |
| @C_Subject_Verb(<input>) | Verb used to describe how the “Entity Value” |
| | relates to this attribute value. This elaborates |
| | the class attributes with a part of the speech |
| | context. |
| @C_Object_Verb(<input>) | Verb used to describe how this attribute value |
| | relates to the “Entity Value”. This elaborates |
| | the class attributes with a part of the speech |
| | context. |
| @C_Pronoun | Value of this attribute is a pronoun; (only) if |
| | this is specified, then the system will look for |
| | this attribute to answer a question related to a |
| | pronoun. This elaborates the class attributes |
| | with a part of the speech context. |
| @C_5W(Who, Where, When) | This attaches a meaning to an attribute of the |
| | question type class for categorizing its value |
| | into being location-related (where), person- |
| | related (who), time related (when), rationale |
| | related (why). |
| | Only when this is specified will the system |
| | look for this attribute to answer questions |
| | related to “Who/Whom”, “Where”, “When” |
| | accordingly. For all other question types, all |
| | attributes are searched. |

The following example illustrates the use of the information in Tables 1-3 for the use case examples:

Listing 3
Workshop Class Attributes

| | |
|---|---|
| @C_Entity | // for the class “WS”, it is an entity |

| | |
|---|---|
| @C_Noun(“workshop”) | // workshop is the noun to describe this |

class
class WS {

| | |
|---|---|
| @C_Entity_Value | // value of “_n” represents this entity, |

| e.g. “IBM Cloud ® for developers is a workshop” | |
|---|---|
| @C_Pronoun | // values of this attribute are pronouns, |

| e.g. “IBM Cloud ® for developers” is a pronoun | |
|---|---|
| @C_Noun(“title”) | // describes this attribute, e.g. |

| “workshop title is IBM Cloud ® for developers” | |
|---|---|
| String _n; | |
| @C_5W(“where”)// for “Where type” questions, this attribute | |
| will be searched | |
| @C_Noun(“location”) | // describes this attribute, e.g. |

| “IBM Cloud ® for developers location is Room A” | |
|---|---|
| @C_Subject_Verb(“held in”)// when the “Entity Value” is a | |
| subject, this attribute describes the predicate, e.g. “IBM | |
| Cloud ® for developers held in Room A” | |
| String _r; | |
| @C_5W(“who”) | // for “Who type” questions, this attribute |

| will be searched | |
|---|---|
| @C_Noun(“organizer”) | // describes this attribute, e.g. |

“IBM Cloud ® for developers organizer is Tinny Ng
@C_Object_Verb(“organize”)// when the “Entity Value” is an
object, this annotation describes the predicate, e.g.
“Tinny Ng organize IBM Cloud ® for developers”
String _org;

}

The question analyzer 415 analyzes questions that are received from a user 405 (the user and the user's device 405 are used interchangeably herein) and decomposes them into a question type and parts of speech, using the chat annotation language (discussed above). The <thesaurus list> simply means that a word and its synonyms may be used in the search. The part of speech may be broken down into a first part that is subject or object, and a second part that is noun, pronoun, or verb.

TABLE 4
Chat Annotation Class Attributes

| Class Attribute | Question Type & Parts of Speech |
|---|---|
| C_5W | Question type |
| C_Subject_Pronoun | Subject of the question is a pronoun |
| C_Subject_Noun(<thesaurus | Subject of the question is a noun (other |
| list>) | thesaurus nouns are listed apart from the |
| | one used in the question) |
| C_Subject_Verb(<thesaurus | Subject verb of the question (other |
| list>) | thesaurus verbs are listed apart from |
| | the one used in the question) |
| C_Object_Pronoun | Object of the question is a pronoun |
| C_Object_Noun(<thesaurus | Object of the question is a noun (other |
| list>) | thesaurus nouns are listed apart from |
| | the one used in the question) |
| C_Object_Verb(<thesaurus | Object verb of the question (other |
| list>) | thesaurus verbs are listed apart from |
| | the one used in the question) |

By way of example, the question analyzer 415 may process the following questions as indicated below:

TABLE 5
Decomposed Question Type and Parts of Speech (415)

| | Decomposed Question Type and Parts of |
|---|---|
| Question | Speech |
| “What are the workshops?” | {“C_5W”: “what”, |
| | “C_Subject_Noun”: [“workshop”, |
| | “class”, “lab”]} |
| “Where is IBM Cloud ® | {“C_5W”: “where”, |
| for Developers?” | “C_Subject_Pronoun”: “IBM Cloud ® |
| | for Developers”} |
| “Who chairs the IBM | {“C_5W”: “who”, “C_Object_Verb”: |
| Cloud ® for Developers?” | [“chair”, “organize”, “own”], |
| | “C_Object_Pronoun”: “IBM Cloud ® for |
| | developers”} |

The analytic engine 425 utilizes the decomposed question type and parts of speech information. It identifies the correct model to use, assisted by the model/data mapping/chat annotation parser 420, by mapping the question inputs with the annotated attributes as follows:

TABLE 6
Model Mapping (420, 425)

| Question Type & | |
|---|---|
| Parts of Speech | Model Mapping (Identifying the Data Model) |
| C_5W | If it's who/whom, where, when, then look for |
| | attributes that has @C_5W(Who, Where, |
| | When); otherwise, all attributes will be |
| | searched |
| C_Subject_Pronoun/ | Look for attributes that have @C_Pronoun |
| C_Object_Pronoun | marked |
| C_Subject_Noun/ | Look for attributes that have @C_Noun |
| C_Object_Noun | marked |
| C_Subject_Verb/ | Look for attributes that has |
| C_Object_Verb | @C_Subject_Verb/@C_Object_Verb |
| | marked |

In addition to performing the model mapping, the analytic engine 425 may: answer follow-on questions by traversing the relationships among the associated data model; leverage data mapping information (e.g., JPA) and work with the data connector 430 to retrieve the corresponding values from the database; and generate output and capture it using description language for the answer composer 435: C_Entity, C_Entity_Value, C_Noun, C_Value, C_Subject_Verb, and C_Object_Verb.

The following examples illustrate a use case answer provided by the analytic engine 425 to various questions:

TABLE 7
Analytic Engine (425) and Answer Composer (435) Answers

| | Analytic Engine 425 Answer | Answer Composer 435 Answer |
|---|---|---|
| Question | (Description Language) | (User Readable/Plain Text) |
| “What are workshops?” | [{“C_Entity”: “workshop”, | “Introduction to Watson is a |
| | “C_Entity_Value”: “Introduction | workshop” and |
| | to Watson”}, {“C_Entity”: | “IBM Cloud ® for developers is a |
| | “workshop”, “C_Entity_Value”: | workshop” |
| | “IBM Cloud ® for developers”}] | |
| “Where is IBM Cloud ® | {“C_Noun”: “room”, | “Room is Room A” |
| for Developers?” | “C_Value”: “Room A”} | |
| “Who organized IBM | {“C_Noun”: “organizer”, | “Organizer is Tinny Ng” |
| Cloud ® for | “C_Value”: “Tinny Ng”} | |
| Developers?” | | |

The data connector 430 provides connectivity to the structured data 470 and utilizes database queries, such as a query using the Structured Query Language (SQL) to retrieve information from it.

The answer composer 435 turns the answer provided by the analytic engine 425 into a human readable form with the grammar fixed using various rules, such as:

Listing 4
Rule Listing for Answer Composer (435)

<C_Entity_Value> is a <C_Entity>
<C_Noun> is <C_Value>
<C_Entity_Value> [<C_Noun> is <C_Value>]*
<C_Entity_Value> <C_Subject Verb> <C_Value>
<C_Value> <C_Object Verb> <C_Entity_Value>

The asterisk in Listing 4 means that the answer can have more than one [<C_Noun> is <C_Value>] in the response. Table 7 illustrates the example human readable answers that may be provided by the answer composer 435.

A more advanced example follows. A more complex OO model example expands the Workshop class illustrated above to reference another class User for the speaker as well as the organizer. A Java representation of this is presented as:

Listing 5
Expanded Workshop Class Definition
(Expansion of Listing 1)

| | |
|---|---|
| class RU { | // registered user |

| | |
|---|---|
| String _id; | // unique id |

| | |
|---|---|
| String _n; | // name of the user |

}

| | |
|---|---|
| class WS { | // workshop |

| | |
|---|---|
| String _id; | // unique id |

| | |
|---|---|
| String _n; | // title of the workshop |
| String _r; | // room of the workshop |

| | |
|---|---|
| RU _org; | // chair of the workshop |

| | |
|---|---|
| RU _sp; | // speaker of the workshop |
| String _pre | // prereq of the workshop |

}

In this instance, the JPA and database table are as follows:

Listins 6
Expanded Model/Data Mapping JPA
(Expansion of Listing 2)

@Entity
@Table(name=“User”)
class RU {

@Column(name=“userid”)
String _id;
@Column(name=“name”)
String _n;

}
@Entity
@Table(name=“WkShop”)
class WS {

@Column(name=“wkid”)
String _id;
@Column(name=“wktitle”)
String _n;
@Column(name=“room”)
String _r;
@ManyToOne
@JoinColumn(name=“chair”, referencedColumnName=“userid”)
RU _org;
@ManyToOne
@JoinColumn(name=“spk”, referencedColumnName=“userid”)
RU _sp;
@Column(name=“prereq”)
String _pre;

}

TABLE 8
Example Name Table

| UserID | Name |
|---|---|
| tng | Tinny Ng |
| dhmlau | Diana Lau |
| mjohnson | Mary Johnson |

TABLE 9
Example Workshop Table

| WkID | WkTitle | Room | Chair | Spk | PreReq |
|---|---|---|---|---|---|
| 1234 | Introduction | Conf. | dhmlau | tag | IBM Cloud ® |
| | to Watson | Ctr. 1 | | | for Developers |
| 4567 | IBM Cloud ® | Room | tag | mjohnson | None |
| | for Developers | A | | | |

The following chat annotation is added to these two classes:

| @C_Entity | |
|---|---|
| @C_Noun(“user”) | |
| class RU { | // user |

| String _id; | // this one has no annotation which means it |
|---|---|
| won't be used directly in searching answer | |
| @C_Entity_Value | |
| @C_Pronoun | |
| @C_Noun(“name”) | |
| String _n; | // name of the user |

}
@C_Entity
@C_Noun(“workshop”)
class WS {

| | |
|---|---|
| String _id | // this one has no annotation which means it |

won't be used directly in searching answer
@C_Entity_Value
@C_Pronoun
@C_Noun(“title”)
String _n;
@C_5W(“where”)
@C_Noun(“location”)
@C_Subject_Verb(“held in”)
String _r;
@C_5W(“who”)
@C_Noun(“organizer”)
@C_Object_Verb(“organize”)
RU _org;
@C_5W(“who”)
@C_Noun(“speaker”)
@C_Object_Verb(“speak for”)
RU _sp;
@C_Pronoun
@C_Noun(“prerequisite”)
@C_Subject_Verb(“require”)
String _pre;

}

### Use Cases

The following are example use cases that illustrate various aspects discussed above.

First Use Case

In the first use case, the user 405 asks the CCB 410, “What are the workshops?” The question analyzer 415 decomposes this question into {“C_5 W”:“what”, “C_Subject_Noun”: [“workshop”, “class”, “lab” ]}. Since the question is a simple “what” question, the analytic engine 425 performs the following operations. First, it looks for all attributes, given the question. Second, it looks for all nouns @C_Noun in order to make a possible match for the “what” question, including “workshop”, “class”, and “lab”. It finds the class WS which has @C_Noun(“workshop”). Third, since @C_Noun(“workshop”) belongs to a class (@C_Entity), the engine will use its @C_Entity_Value to answer the question (i.e., the value of the attribute String_n;). Fourth, since there are no further details being asked, the analytic engine 425 will just retrieve the value of _n from all the workshop rows in the table using the data connector 430. The answer will be formulated as [{“C_Entity”: “workshop”, “C_Entity_Value”:“Introduction to Watson”}, {“C_Entity”: “workshop”,“C_Entity_Value”:“IBM Cloud® for developers”}]. Finally, the answer composer 435 turns the answer into human readable form with the grammar fixed, using a rule such as <C_Entity_Value> is a <C_Entity>. The resultant answer provided to the user 405 is thus: “Introduction to Watson is a workshop, and IBM Cloud® for developers is a workshop”.

Second Use Case

In the second use case, the user 405 asks the CCB 410, “Who are the speakers?” The question analyzer 415 decomposes the question into {“C_5 W”:“who”, “C_Subject_Noun”: [“speaker”, “presenter” ]}. Since the question is a simple “who” question, the analytic engine 425 performs the following operations. First, it only looks for those attributes that have @C_5 W(“who”) marked. In this case, only RU_org and RU_sp in class WS have “who” marked. Second, it looks for the @C_Noun to do a match for “speaker”, “presenter”, and thus refines the search to RU_sp only, since it has @C_Noun(“speaker”). Third, since @C_Noun(“speaker”) belongs to the class WS, the analytic engine 425 will retrieve the value of _sp from all the workshop rows using the data connector 430. Fourth, according to the OO model, _sp is an RU object—the analytic engine 425 traces this relationship and uses the @C_Entity_Value of RU instead of using the spk column value directly in order to answer the question. The answer will be formulated as [{“C_Noun”: “speaker”, “C_Value”: “Tinny Ng”}, {“C_Noun”: “speaker”, “C_Value”:“Mary Johnson”}]. Finally, the answer composer 435 turns the answer into human readable form with the grammar fixed, using a rule such as <C_Noun> is <C_Value>. The resultant answer provided to the user 405 is thus: “speaker is Tinny Ng and speaker is Mary Johnson”.

Third Use Case

In the third use case, the user 405 asks the CCB 410, “What is IBM Cloud® for developers?” The question analyzer 415 decomposes the question into {“C_5 W”: “what”, “C_Subject_Pronoun”: “IBM Cloud® for developers”}. Since the question is a simple “what” question, the analytic engine 425 performs the following operations. First, it looks for all attributes, given the question. Second, it only looks for those attributes that have @C_Pronoun, refines the search to _n in class RU, _t and _pre in class WS. Third, using the data connector 430, the analytic engine 425 retrieves values of these three attributes from the database 470 and finds matches for “IBM Cloud® for developers”. It also finds two rows in the workshop table that match, one match is used as a title, and another match appears as a prerequisite for something else. The answer will be formulated as [{“C_Entity”: “workshop”, “C_Entity_Value”:“IBM Cloud® for developers”}, {“C_Entity_Value”:“Introduction to Watson”, “C_Noun”: “prerequisite”, “C_Value”:“IBM Cloud® for developers”}]. Finally, the answer composer 435 turns the answer into human readable form with the grammar fixed using a rule such as <C_Entity_Value> is a <C_Entity> and <C_Entity_Value>[<C_Noun> is <C_Value>]*. The resultant answer provided to the user 405 is thus: “IBM Cloud® for developers is a workshop, and Introduction to Watson is a prerequisite for IBM Cloud® for developers”.

Fourth Use Case

In a fourth use case, the user 405 asks the CCB 410, ““Where is it?” The Question Analyzer 415 decomposes the question into {“C_5 W”:“where”}. The analytic engine 425 performs the following operations. First, it only looks for those attributes that have @C_5 W(“where”) marked—in this case, only _r in class WS. Since there are no further details, the analytic engine 425 will first look for the answer based on a history of the chat session. According to the history, the last answer came from the two rows in the workshop. Thus, the analytic engine uses the value of _r in these two rows to form the answer. The answer will be formulated as [{“C_Entity_Value”: “IBM Cloud® for developers”, “C_Noun”: “room”, “C_Value”:“Room A”}, {“C_Entity_Value”:“Introduction to Watson”, “C_Noun”: “room”, “C_Value”:“Conf. Ctr. 1”}]. Finally, the answer composer 435 turns the answer into human readable form with the grammar fixed using a rule, such as <C_Entity_Value>[<C_Noun> is <C_Value>]*. The resultant answer provided to the user 405 is thus: “IBM Cloud® for developers room is Room A and Introduction to Watson room is Conf. Ctr 1”.

Fifth Use Case

In the fifth use case, the user 405 asks the CCB, “Who chairs the IBM Cloud® for developers?” The question analyzer 415 decomposes the question into {“C_5 W”:“who”, “C_Object_Pronoun”:“IBM Cloud® for developers”, “C_Object_Verb”:[“chair”, “organize”, “own” ]}. First, the analytic engine 425 only looks for those attributes that have @C_5 W(“who”) marked—in this case only RU_org and RU_sp in class WS. Second, the analytic engine 425 looks for the @C_Object_Verb to find a match for “chair”, “organize”, “own”, and so refines the search to RU_org only, since it has the @C_Object_Verb(“organize”). Third, since_org is a @C_Object_Verb and belongs to the class WS, the analytic engine 425 will look for all of its entity values which acts as an object to match the “C_Object_Pronoun”:“IBM Cloud® for developers” using the data connector 430. According to the OO model, _sp is an RU object—the analytic engine 425 will trace this relationship and use the @C_Entity_Value of RU instead of using the chair column value directly to answer the question. The answer will thus be formulated as {“C_Entity_Value”: “IBM Cloud® for developers”, “C_Object_Verb”: “organize”, “C_Value”:“Tinny Ng”}. The answer composer 435 turns the answer into human readable form with the grammar fixed using a rule such as <C_Value><C_Object Verb><C_Entity_Value>. The resultant answer provided to the user 405 is thus “Tinny Ng organizes IBM Cloud® for developers”.

Sixth Use Case

In a sixth use case, the user 405 asks the CCB “What does Tinny Ng chair?” The question analyzer 415 decomposes this question into {“C_5 W”:“what”, “C_Subject_Pronoun”: “Tinny Ng”, “C_Subject_Verb”:[“chair”, “organize”, “own” ]}. First, the analytic engine 425 looks for all attributes as the question is simply “what”. The analytic engine 425 then looks for the @C_Subject_Verb to do a match for “chair”, “organize”, “own”, but cannot find anything. The analytic engine 425 then looks for those attributes that have @C_Pronoun to see if there is a match for “Tinny Ng”. Such a match is found once in the column named User in the table (i.e., _n of class RU). But this class does not have any @C_Subject_Verb that matches “chair”, “organize”, or “own”. The analytic engine 425 further traces the OO and finds the class RU is being used in class WS. In this case, the analytic engine searches the table there and finds “tng” from the column “chair” and the column “spk” in two rows. I then traces the RU_org and RU_sp in class WS and looks for @C_Object_Verb to match for “chair”, “organize”, “own”, since “tng” is a subject here and the workshop entity value is an object here. The analytic engine 425 finally finds a match, and the answer will thus be formatted as {“C_Entity_Value”:“IBM Cloud® for developers”, “C_Object_Verb”: “organize”, “C_Value”:“Tinny Ng”}. The answer composer 435 turns the answer into human readable form with grammar fixed using a rule such as <C_Value><C_Object Verb><C_Entity_Value>. The resultant answer provided to the user 405 is thus “Tinny Ng organize IBM Cloud® for developers”.

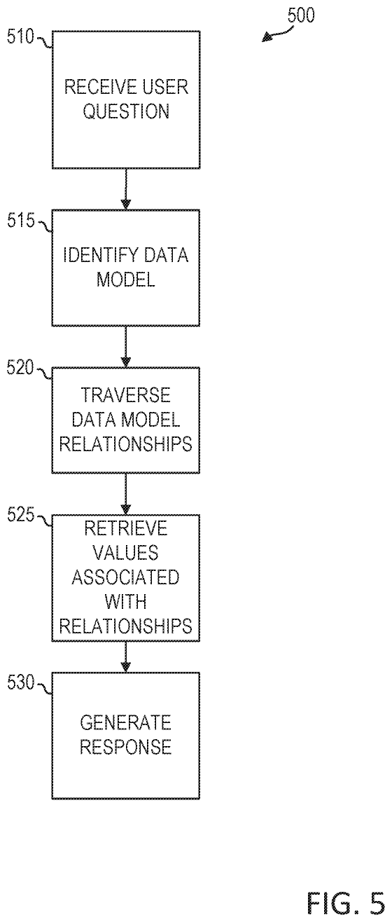

FIG. 5 is a flowchart illustrating a process 500 that may be used to implement the cognitive chatbot (CCB) 410, according to some embodiments. In operation 510, the CCB 410 receives a question from a user 405. In operation 515, the MDMCAP 420 identifies a model for the question by parsing the question into a question type and parts of speech. Based on the identified model, utilizing the analytic engine 425, in operation 520 the CCB 410 traverses data model relationships that are stored in the structured database 470. In operation 525, values are retrieved from the database 470 that are associated with the data model relationships utilizing the data connector 430. In operation 530, a response to the question is generated. The response may be initially created by the analytic engine 425 using a description language discussed herein, but it may then be converted, by the answer composer 435 into user-readable/plain text for output to the user device 405.

### Computer Technology and Computer Readable Media

The one or more embodiments disclosed herein accordingly provide an improvement to computer technology. For example, an improvement to a chatbot and use of data schema for searching allows for a more efficient and effective search for information by the user. The ability to update data within the database without requiring a retraining of the chatbot when the underlying schema has not changed allows an efficient management of a database utilized by the chatbot. It also improves the operation of the chatbot and benefits the user in that more pertinent results may be presented to the user.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising using a processor for:
in response to receiving a question from a user during a messaging session, analyzing the question into respective annotated portions associated with predetermined attributes of the question including a question type and part of speech;
identifying a data model using mapping information defined in the data model with only analyzed predetermined attributes of the question;
traversing relationships among the data model identified, in a database, using the mapping information;
retrieving corresponding values associated with the relationships from the database data; and
generating a response to the question using the corresponding values retrieved.

2. The method of claim 1, further comprising:
composing a user-readable response to the question from the response to the question utilizing a set of predefined composition rules; and
outputting the user-readable response to a device associated with the user.

3. The method of claim 2, wherein the set of predefined rules comprise:
<C_Entity_Value> is a <C_Entity>
<C_Noun> is <C_Value>
<C_Entity_Value>[<C_Noun> is <C_Value>]*
<C_Entity_Value><C_Subject Verb><C_Value>
<C_Value><C_Object Verb><C_Entity_Value>

4. The method of claim 1, wherein the analyzing of the question type comprises determining the question type to be who, where, when, or other.

5. The method of claim 4, further comprising:
responsive to the determining of the question type to be who, setting an attribute search type to be who;
responsive to the determining of the question type to be where, setting an attribute search type to be where;
responsive to the determining of the question type to be when, setting an attribute search type to be when; and
responsive to the determining of the question type to be other, setting an attribute search type to be all attributes.

6. The method of claim 1, wherein the analyzing of the parts of speech comprises determining the part of speech to be a first part that is a subject or an object, and a second part that is a noun, pronoun, or verb.

7. The method of claim 1, wherein the identifying of the data model comprises selecting a data model as follows:
responsive to the part of speech being either a subject pronoun or object pronoun, then searching for attributes that have a pronoun attribute marked;
responsive to the part of speech being either a subject noun or object noun, then searching for attributes that have a noun attribute marked; and
responsive to the part of speech being either a subject verb or object verb, then searching for attributes that have a subject verb or object verb attribute marked.

8. The method of claim 1, wherein the database is structured according to object oriented classes.

9. The method of claim 8, wherein:
object classes are represented in an object-oriented model;
data mapping utilizes a model-data mapping annotation; and
chat predetermined attributes are defined using a chat annotation.

10. The method of claim 9, further comprising:
identifying the response in the chat annotation by using the chat predetermined attributes.

11. A cognitive chatbot system, comprising:
a processor configured to:
in response to receiving a question from a user during a messaging session, analyze the question into respective annotated portions associated with predetermined attributes of the question including a question type and part of speech;
identify a data model using mapping information defined in the data model with only analyzed predetermined attributes of the question;
traverse relationships among the data model identified, in a database, using the mapping information;
retrieve corresponding values associated with the relationships from the database data; and
generate a response to the question using the corresponding values retrieved.

12. The system of claim 11, wherein the processor is further configured to:
compose a user-readable response to the question from the response to the question utilizing a set of predefined composition rules; and
output the user-readable response to a device associated with the user.

13. The system of claim 12, wherein the set of predefined rules comprise:
<C_Entity_Value> is a <C_Entity>
<C_Noun> is <C_Value>
<C_Entity_Value>[<C_Noun> is <C_Value>]*
<C_Entity_Value><C_Subject Verb><C_Value>
<C_Value><C_Object Verb><C_Entity_Value>

14. The system of claim 11, wherein the analysis of the question type comprises determining the question type to be who, where, when, or other.

15. The system of claim 14, wherein the processor is further configured to:
responsive to the determination of the question type to be who, set an attribute search type to be who;
responsive to the determination of the question type to be where, set an attribute search type to be where;
responsive to the determination of the question type to be when, set an attribute search type to be when; and
responsive to the determination of the question type to be other, set an attribute search type to be all attributes.

16. The system of claim 11, wherein the analysis of the parts of speech comprises a determination of the part of speech to be a first part that is a subject or an object, and a second part that is a noun, pronoun, or verb.

17. The system of claim 11, wherein the identification of the data model comprises a selection of a data model as follows:
responsive to the part of speech being either a subject pronoun or object pronoun, then searching for attributes that have a pronoun attribute marked;
responsive to the part of speech being either a subject noun or object noun, then searching for attributes that have a noun attribute marked; and
responsive to the part of speech being either a subject verb or object verb, then searching for attributes that have a subject verb or object verb attribute marked.

18. The system of claim 11, wherein the database is structured according to object oriented classes.

19. The system of claim 18, wherein:
object classes are represented in an object-oriented model;
data mapping utilizes a model-data mapping annotation; and
chat predetermined attributes are defined using a chat annotation.

20. A computer program product for a chatbot system, the computer program product comprising a computer readable storage medium having computer-readable program code embodied therewith to, when executed on a processor:
in response to receiving a question from a user during a messaging session, analyze the question into respective annotated portions associated with predetermined attributes of the question including a question type and part of speech;
identify a data model using mapping information defined in the data model with only analyzed predetermined attributes of the question;
traverse relationships among the data model identified, in a database, using the mapping information;
retrieve corresponding values associated with the relationships from the database data; and
generate a response to the question using the corresponding values retrieved.
